(19) United States
(12) Patent Application Publication
(10) Pub. No.: US 2009/0319666 A1
(43) Pub. Date: Dec. 24, 2009

(54) Method and Apparatus for Session Initiated Protocol (SIP) Based Information Uploading from an Optical Network Terminal (ONT)

(76) Inventors: Shih-Chang Liang, Rockville, MD (US); David H. Liu, Herndon, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/141,594

(22) Filed: Jun. 18, 2008

(51) Int. Cl. G06F 15/16

(52) U.S. Cl. 709/227

(57) ABSTRACT

Collecting diagnostic information from a remote device in today's networks is limited to system related information. However, of more interest to vendors of commercial products or services is information related to, for example, how their products, services or advertisement are perceived by end users. Accordingly, a method and corresponding apparatus according to an embodiment of the present invention are provided that extends the Session Initiated Protocol (SIP) NOTIFY mechanism. Originally defined for server to client or downstream notification of a state of a resource or of an event, the present invention extends this functionality to include uploading information other than a state of a resource or of an event from the client to the server or upstream. As such, information, such as usage behavior of a user, may now be collected to understand end user perception of products, services or advertisements.

### BACKGROUND OF THE INVENTION

Session Initiation Protocol (SIP) is an application-layer control (signaling) protocol for creating, modifying, and terminating sessions with one or more participants or end-nodes. These sessions include Internet telephone calls, multimedia distribution, and multimedia conferences. The ability to request asynchronous notification of events proves useful in many types of SIP services for which cooperation between end-nodes is required. Examples of such services include automatic callback services (based on terminal state events), buddy lists (based on user presence events), message waiting indications (based on mailbox state change events), and Public Switched Telephone Network (PSTN), and Internet Internetworking (PINT) status (based on call state events).

### SUMMARY OF THE INVENTION

Example embodiments of the present invention may be implemented in the form of a method or corresponding apparatus that communicates information in a session initiated protocol (SIP) network. A method and corresponding apparatus according to one embodiment of the present invention includes, while requesting a SIP server, notify a SIP subscriber during a SIP dialog with information of a state of a resource or of an event, informing the SIP server that the SIP subscriber uploads information other than a state of a resource or an of an event, and uploading the information as informed to the SIP server during the SIP dialog.

A method and corresponding apparatus according to another embodiment of the present invention includes creating a subscription responsive to a SIP subscriber requesting to be notified with information of a state of a resource or of an event during a SIP dialog, and responsive to the SIP subscriber informing that the SIP subscriber uploads information other than a state of a resource or of an event during the SIP dialog. And during the SIP dialog, notifying the SIP subscriber with information of a state of a resource or of an event as requested, while being uploaded by the SIP subscriber with information other than a state of a resource or an of an event as informed.

A method and corresponding apparatus according to yet another embodiment of the present invention includes creating a subscription by requesting to be notified by a SIP server with information of a state of a resource or of an event during a SIP dialog, and informing the SIP server that the SIP server is to be uploaded with information other than a state of a resource or of an event during the SIP dialog. And during the SIP dialog, uploading the SIP server with information other than a state of a resource or of an event as informed, while being notified by the SIP server with information of a state of a resource or of an event as requested.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a ladder diagram of an example SIP dialog, in accordance with example embodiments of the present invention;

FIGS. 2A-2H are message diagrams of SIP messages communicated during a SIP dialog, in accordance with example embodiments of the present invention;

FIG. 3 is a flowchart of an example process for communicating in a SIP network, in accordance with an example embodiment of the present invention;

FIG. 4 is a flowchart of an example process for communicating in a SIP network between a SIP subscriber and a SIP server, in accordance with example embodiments of the present invention; and

FIGS. 5A-5B are block diagrams of example apparatuses to communicate in a SIP network, in accordance with example embodiments of the present invention.

### DETAILED DESCRIPTION OF THE INVENTION

A description of example embodiments of the invention follows.

Collecting diagnostic information from a remote device is common practice for many communication devices. Currently, only limited system related information can be retrieved from a management system. There is no way to obtain data such as usage behavior of a user. Vendors of commercial products or services are always interested in understanding, for example, how their products, services or advertisements are perceived by end users in each household.

Current approaches for collecting diagnostic information include: i) using a dial-up data call to transmit such information through a plain old telephone system (POTS); and ii) using file transfer protocol (FTP), or the like, to transmit such information through an internet protocol (IP) network. These current approaches are inadequate because: i) a session for transmitting the information is not always up; ii) is not “future proof,” and iii) FTP does not allow instruction or event update from an FTP server.

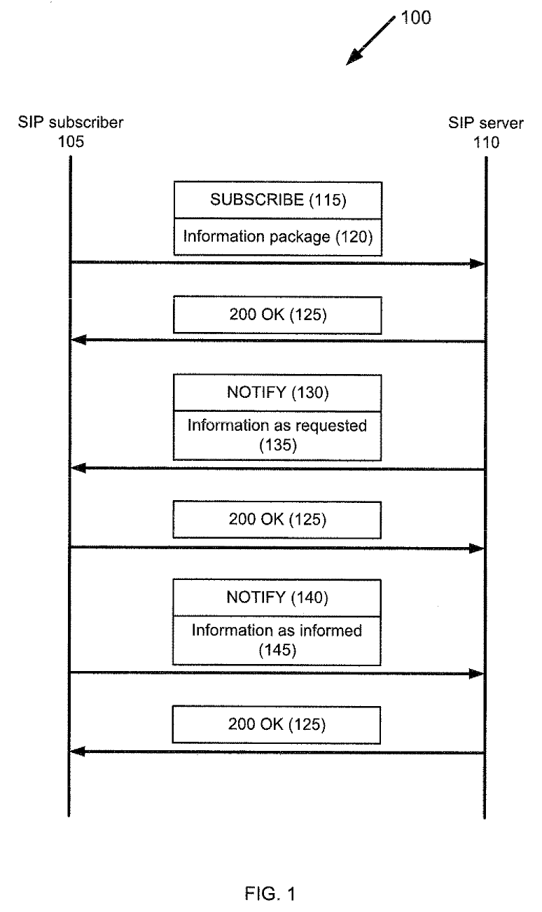

FIG. 1 illustrates, in a session initiated protocol (SIP) network, during a SIP dialog 100, a SIP subscriber 105 and a SIP server 110 communicate. The SIP subscriber 105 requests with a SUBSCRIBE message 115 that the SIP server 110 notify the SIP subscriber 105 with information of a state of a resource or of an event. Additionally, with the same SUBSCRIBE message 115, the SIP subscriber 105 informs the SIP server 110 that the SIP subscriber 105 uploads information other than state of a resource or of an event.

The SUBSCRIBE message 115 conveys or otherwise communicates from the SIP subscriber 105 to the SIP server 110 an information package 120. The information package 120 defines a set of state information to be reported by the SIP server 110 to the SIP subscriber 105. The information package 120 also defines a set of information to be uploaded or otherwise reported by the SIP subscriber 105 to the SIP server 110. In a convenient embodiment, the information package 120 defines further syntax and semantics to convey user, application, and system information including, but not limited to, text, extensible markup language (XML), and multimedia type of data.

The SIP server 110 acknowledges with a 200 OK message 125 the request by the SIP subscriber 105 to be notified with information of a state of a resource or of an event. With the same 200 OK message 125, the SIP server 110 also acknowledges of being informed that the SIP subscriber 105 uploads information other than state of a resource or of an event.

The SIP server 110 notifies the SIP subscriber 105 with a NOTIFY message 130 of information of a state of a resource or of an event. The NOTIFY message 130 conveys or otherwise communicates from the SIP server 110 to the SIP subscriber 105 an information as requested 135. The information as requested 135 corresponds to the information requested with the SUBSCRIBE message 115 and defined by the information package 120. The SIP subscriber 105 acknowledges with a 200 OK message 125 being notified of, for example, a state of a resource or an event occurring.

Continuing with FIG. 1, the SIP subscriber 105 notifies the SIP server 110 with a NOTIFY message 140 of information other than information of a state of a resource or of an event. The NOTIFY message 140 communicates from the SIP subscriber 105 to the SIP server 110 an information as informed 145. The information as informed 145 corresponds to the information informed of by the SUBSCRIBE message 115 and defined by the information package 120. The SIP server 110 acknowledges with a 200 OK message 125 being informed of, for example, user, application or system information.

As illustrated, both the SIP subscriber 105 and the SIP server 110 notify. Accordingly, it may be said that a notification is an act by either a notifier (e.g., the SIP server 110) or a subscriber (e.g., the SIP subscriber 105) sending a notify message (e.g., the NOTIFY message 130 or 140) to the subscriber or the notifier to inform, for example, a state of a resource located on the notifier or subscriber. For the purpose of discussion only, informing a subscriber (or SIP subscriber) with information is referred to hereinafter as “notifying” the subscriber of the information, and informing a notifier (or SIP server) with information is referred to hereinafter as “uploading” the information onto the notifier.

In a convenient embodiment, uploading information other than information of a state of a resource or of an event (e.g., the information as informed 145) onto a SIP server uses substantially the same NOTIFY message (at least in terms of format) for notifying a SIP subscriber with information of a state of a resource or of an event (e.g., the information as requested 135). It is important to distinguish, however, the NOTIFY message is being used for different purposes. The purpose of notifying with a NOTIFY message is to inform the SIP subscriber of a subscribed to state of a resource or event. The purpose of uploading with a NOTIFY message is to inform the SIP server of information not subscribed to and independent of a state of resource or event.

In a convenient embodiment, for SIP services requiring cooperation between end nodes, the foregoing requesting and notifying are performed in accordance with request for comments (RFC) 3265. Example of such services include automatic callback services (based on terminal state events), buddy lists (based on user presence events), message waiting indications (based on mailbox state change events), and PSTN and Internet Internetworking (PINT) status (based on call state events).

Information other than a state of a resource or of an event may not be required, but nonetheless may be useful to upload. Example embodiments upload information to provide, for example:

(1) a rating company with viewing behavior of internet protocol television (IPTV) customers. With internet group management protocol (IGMP) joins and leaves, example embodiments can determine what channel a customer watches at a certain point in time. Additionally, when a customer joins and leaves a channel (e.g., during commercials) or what channels are being watched more frequently;

(2) a rating company with web surfing behavior of high speed internet customers;

(3) a carrier with statistics on use of an optical network terminal (ONT )in a passive optical network (PON). For network planning purposes, the carrier can use example embodiments to understand how the ONT is being used; and

(4) in cases in which a field outage occurs, example embodiments may be used as a tool to send a post-mortem dump from the ONT out to, for example, a server for analysis.

Further it may be useful to upload information and to be notified of information during the same SIP dialog.

To summarize, in accordance with example embodiments of the present invention, a SIP subscriber exhibits the following features: i) receives a NOTIFY request or message from a SIP server, the NOTIFY requests contains information about the state of a resource in which the SIP subscriber is interested; and ii) generates a NOTIFY request or message for the purpose of uploading user, application, and system information onto the SIP server. Further, a SIP server: i) generates a NOTIFY request or message for the purpose of notifying a SIP subscriber of the state of a resource or of an event; and ii) processes a NOTIFY request or message uploading user, application, and system information onto the SIP server.

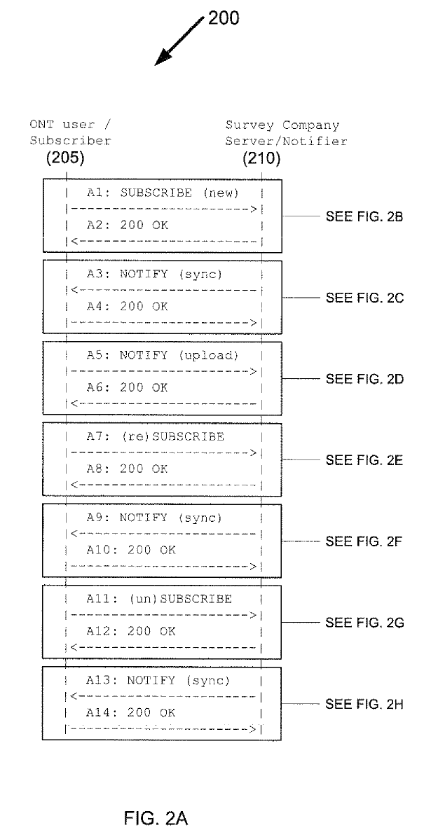

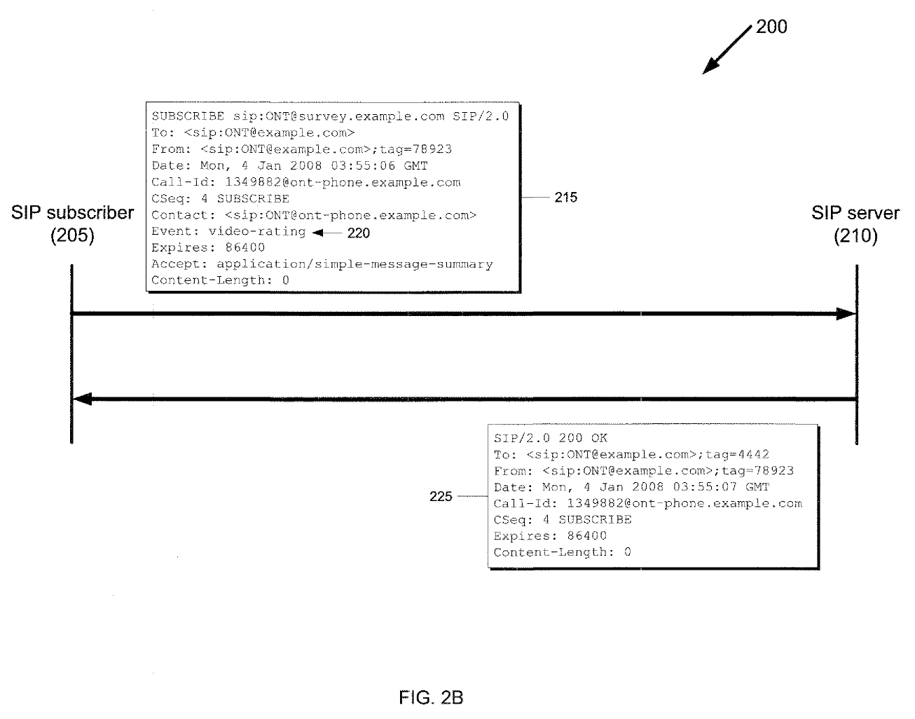

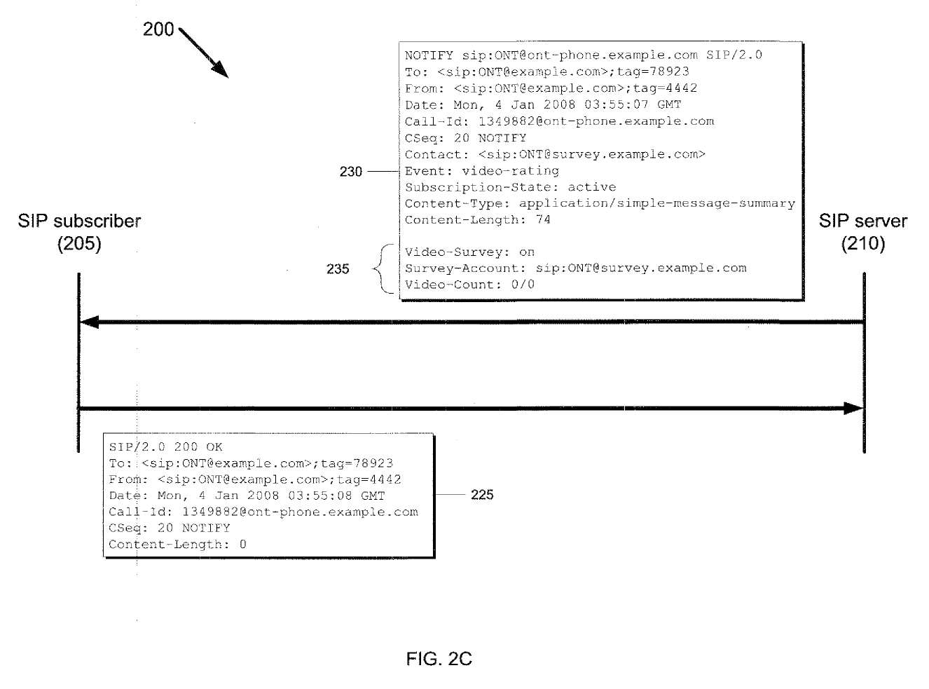

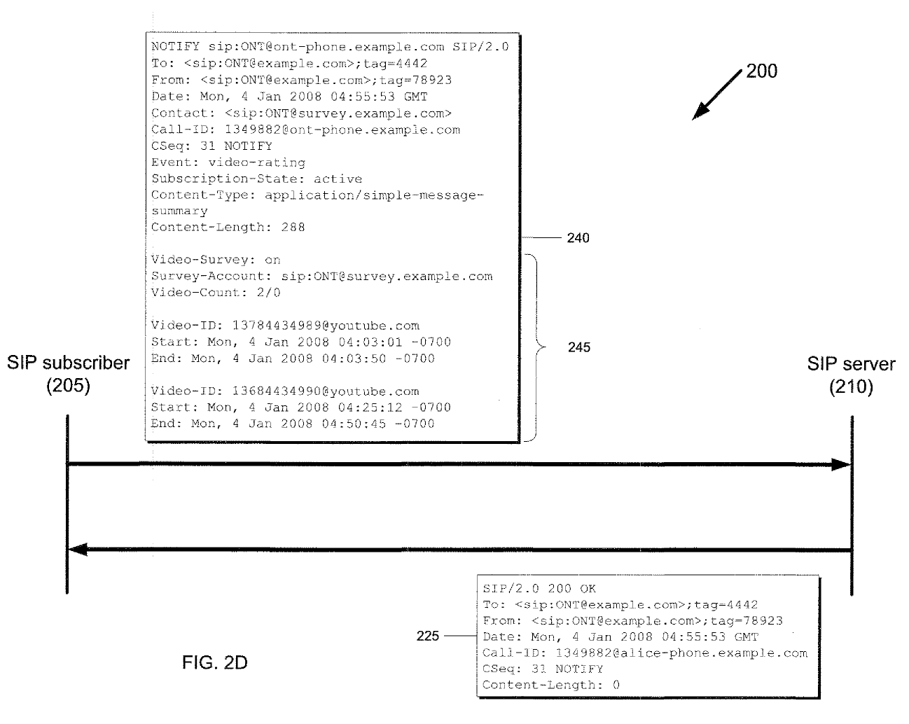

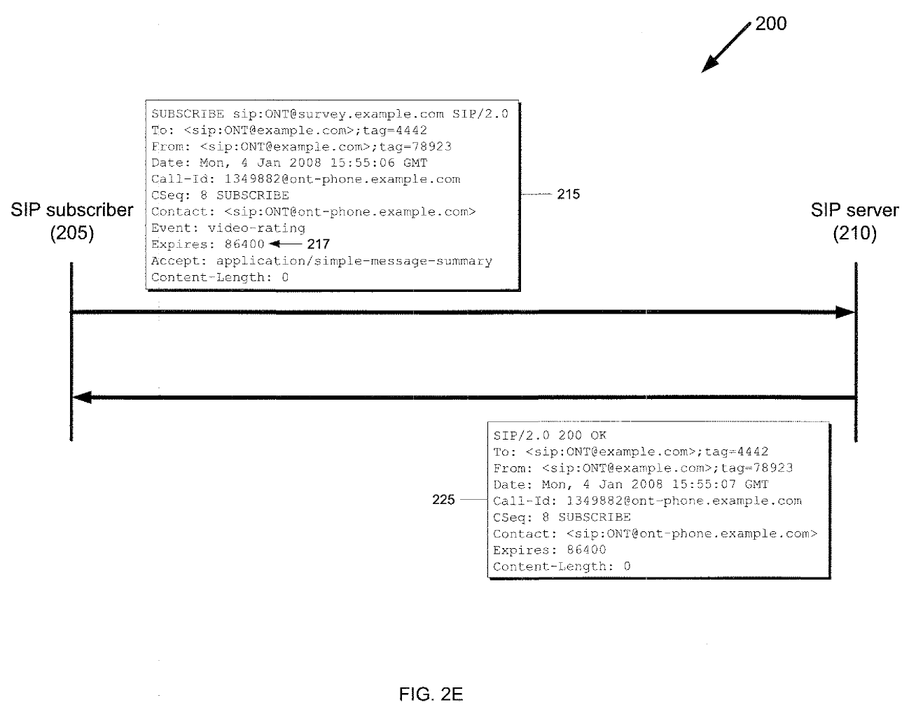

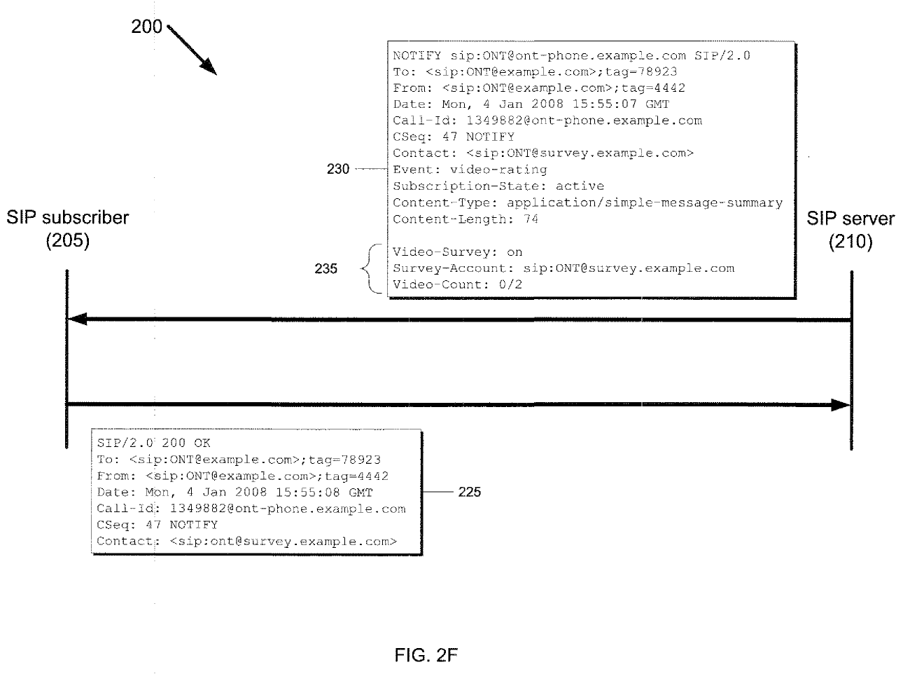

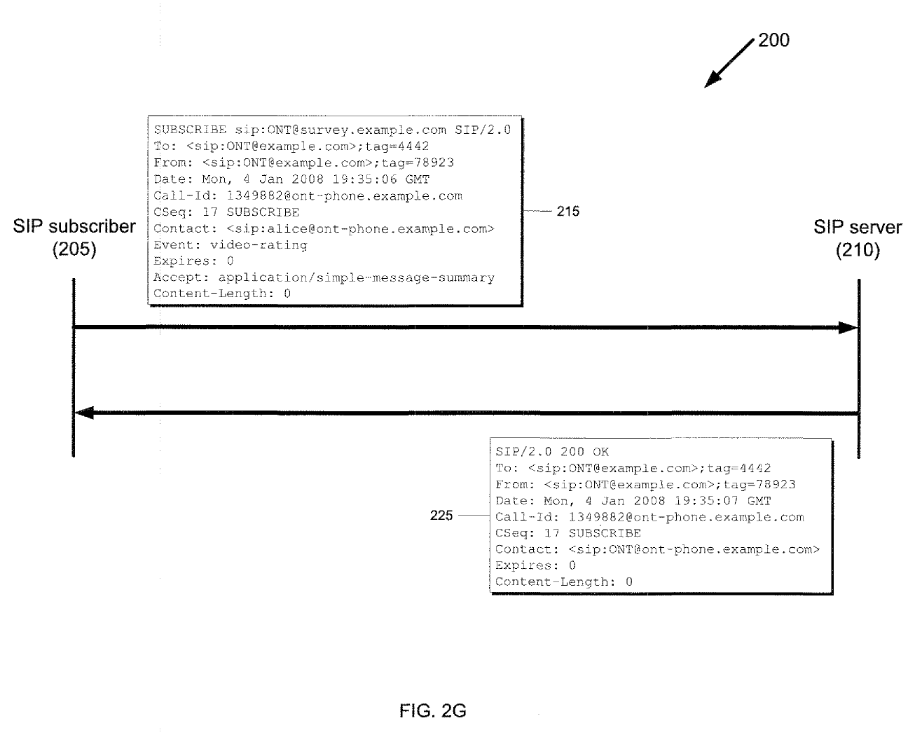

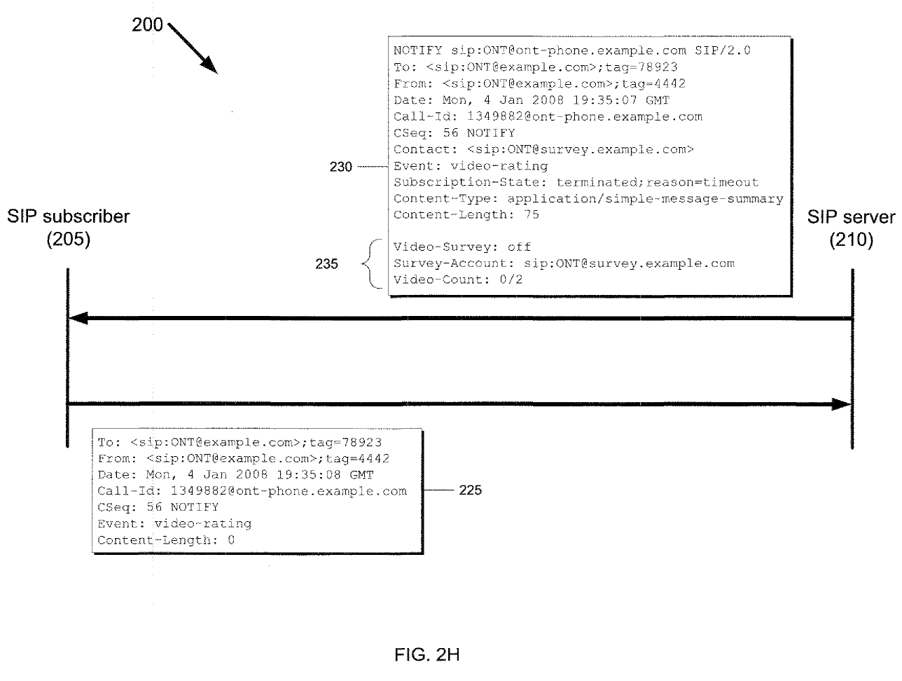

FIGS. 2A-2H illustrate an example demonstrating example embodiments of the present invention in greater detail. In the illustrated example, a user participates in a television programming survey conducted by a rating survey company, such as NIELSEN MEDIA RESEARCH and the like. In a typical scenario, the user is offered a package that involves certain incentives, such as reduced rates for data, voice, and video services (i.e., triple play service). In return, the user agrees to have data on its viewing behavior or characteristic collected in a video viewing survey by the rating survey company. An information package named video-rating is defined for the video viewing survey for the purpose of collecting data on the user's viewing behavior or characteristic (described below in greater detail).

FIG. 2A illustrates in a SIP network, during a SIP dialog 200, a SIP subscriber 205 and a SIP server 210 communicate. In this example, the SIP subscriber 205 is the user who is associated with an optical network terminal (ONT) in a passive optical network (PON) and the SIP server 210 is the rating survey company. The SIP subscriber 205 and the SIP server 210 communicate messages enumerated A1-A14. FIGS. 2B-2H illustrate the message format and content of each message enumerated.

FIG. 2B, the SIP subscriber 205 subscribes to the video viewing survey and requests with a SUBSCRIBE message 215 that the SIP server 210 notify the SIP subscriber 205 with information of a state of a resource or of an event. Additionally, with the same SUBSCRIBE message 215, the SIP subscriber 205 informs the SIP server 210 that the SIP subscriber 205 uploads information other than state of a resource or of an event.

In this example, the SUBSCRIBE message 215 conveys or otherwise communicates from the SIP subscriber 205 to the SIP server 210 a video-rating information package 220. The video-rating information package 220 defines that the SIP server 210 notify the SIP subscriber 205 with: i) a state of the video viewing survey, ii) identify of the video viewing survey account, iii) a total number of videos viewed since last report, and iv) a number of videos viewed in the last report. The video-rating information package 220 also defines that the SIP subscriber 205 upload the SIP server 210 with: i) a total number videos viewed from last report, ii) a number of videos viewed in the last report, and iii) identity of the videos viewed.

The SIP server 110 acknowledges with a 200 OK message 225 the request by the SIP subscriber 205 to be notified with the information as requested and defined the video-rating information package 220. With the same 200 OK message 225, the SIP server 110 also acknowledges of being informed that the SIP subscriber 105 uploads the information as informed and defined the video-rating information package 220.

As the video-rating information package 220 of this example demonstrates, embodiments of the present invention inform a SIP server that a SIP subscriber uploads information other than information of a state of a resource or of an event. In this particular example, the SIP subscriber 205 informs the SIP server 210 that it uploads the identity of videos viewed by the user.

FIG. 2C, the SIP server 210 notifies the SIP subscriber 205 with a NOTIFY message 230 of information of a state of a resource or of an event. The NOTIFY message 230 conveys or otherwise communicates from the SIP server 210 to the SIP subscriber 205 an information as requested 235. The information as requested 235 corresponds to the information requested with the SUBSCRIBE message 215 and defined by the video-rating information package 220. Further, because the SIP subscriber 205, once informed, has the same information of a state of a resource or of an event as the SIP server 210, it may be said that the NOTIFY message 230 synchronizes a current state of a subscribed to state or event.

In this example, the SIP server 210 notifies the SIP subscriber 205 with: i) the state of the video viewing survey (viz., on), ii) the identity of the video viewing survey account (viz., sip:ONT@survey.example.com), iii) the total number of videos viewed since last report (viz., 0), and iv) the number of videos viewed in the last report (viz., 0).

The SIP subscriber 205 acknowledges with a 200 OK message 225 being notified with the foregoing.

FIG. 2D, the user watches two video clips from YOUTUBE after subscribing to the video viewing survey. Given the user's viewing behavior or characteristic as detected and stored by, for example, the ONT, the SIP subscriber 205 notifies the SIP server 210 with a NOTIFY message 240 of information other than information of a state of a resource or of an event. The NOTIFY message 240 communicates from the SIP subscriber 205 to the SIP server 210 an information as informed 245. The information as informed 245 corresponds to the information informed of by the SUBSCRIBE message 215 and defined by the video-rating information package 220.

In this example, the SIP subscriber 205 uploads the SIP server 210 with: i) the total number videos viewed from last report (viz., 2), ii) the number of videos viewed in the last report (viz., 0), and iii) the identity of the videos viewed (viz., 13784434989@youtube.com and 13684434990@youtube.com). The SIP server 210 acknowledges with a 200 OK message 225 being informed with the foregoing.

FIG. 2E, maintaining the SIP dialogue 200, the SIP subscriber 205 continues uploading information as requested as defined by the video-rating information package 220. The SIP subscriber 205 re-subscribes with the SUBSCRIBE message 215 with a time to expire 217 refreshed or otherwise updated. As described previously, with the SUBSCRIBE message 215, the SIP subscriber 205 subscribes to the video viewing survey and requests that the SIP server 210 notify the SIP subscriber 205 with information of a state of a resource or of an event. Additionally, with the same SUBSCRIBE message 215, the SIP subscriber 205 informs the SIP server 210 that the SIP subscriber 205 uploads information other than state of a resource or of an event.

The SIP server 110 acknowledges with the 200 OK message 225 the request by the SIP subscriber 205 to be notified with the information as requested and defined the video-rating information package 220. With the same 200 OK message 225, the SIP server 110 also acknowledges of being informed that the SIP subscriber 105 uploads the information as informed and defined by the video-rating information package 220.

FIG. 2F, maintaining the SIP dialogue 200, the SIP server 210 continues notifying information as informed as defined by the video-rating information package 220. The SIP server 200 notifies with the NOTIFY message 230. As described previously, with the NOTIFY message 230, the SIP server 200 notifies the SIP subscriber 205 with information of a state of a resource or of an event. In this example, the NOTIFY message 230 synchronizes the current state of the subscribed to video viewing survey, that is, the information as requested 235 (viz., the state of the state of the video viewing survey is on, the total number videos viewed from last report is 0, and the number of videos viewed in the last report is 2). In a convenient embodiment, the SIP server 200 periodically notifies with the NOTIFY message 230. The SIP subscriber 205 acknowledges with the 200 OK message 225 being notified with the foregoing.

FIG. 2G, releasing the SIP dialogue 200, the SIP subscriber 205 discontinues uploading information as requested and as defined by the video-rating information package 220. The SIP subscriber 205 un-subscribes with the SUBSCRIBE message 215 with the time to expire 217 set to zero. The SIP server 110 acknowledges with the 200 OK message 225 that the SIP subscriber 205 no longer uploads information.

FIG. 2H, releasing the SIP dialogue 200, the SIP server 210 discontinues notifying information as informed and as defined by the video-rating information package 220. In this example, the NOTIFY message 230 synchronizes the current state of the subscribed to video viewing survey, that is, the information as requested 235 (viz., the state of the state of the video viewing survey is off, the total number videos viewed from last report is 0, and the number of videos viewed in the last report is 2).

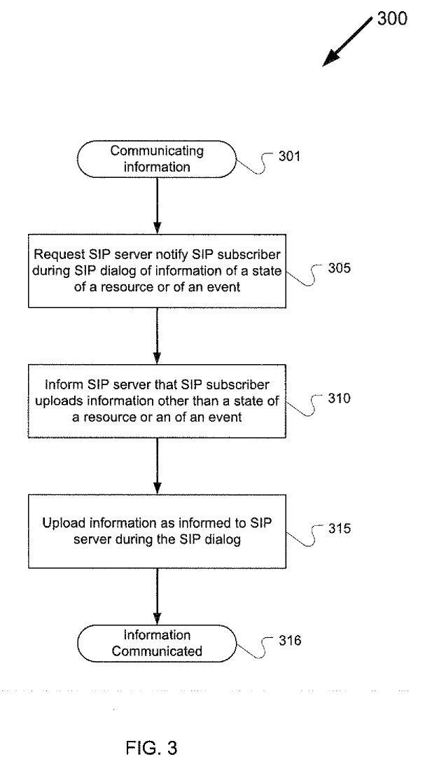

FIG. 3 is a flow diagram that illustrates an example process 300 for communicating information in a SIP network. The process 300 starts (301). The process 300 requests (305) a SIP server notify a SIP subscriber during a SIP dialog with information of a state of a resource or of an event. While the process 300 requests (305), the process 300 informs (310) the SIP server that the SIP subscriber uploads information other than a state of a resource or of an event. The process 300 uploads (315) the information as informed to the SIP server during the SIP dialog. The process 300 ends (316) with the information communicated.

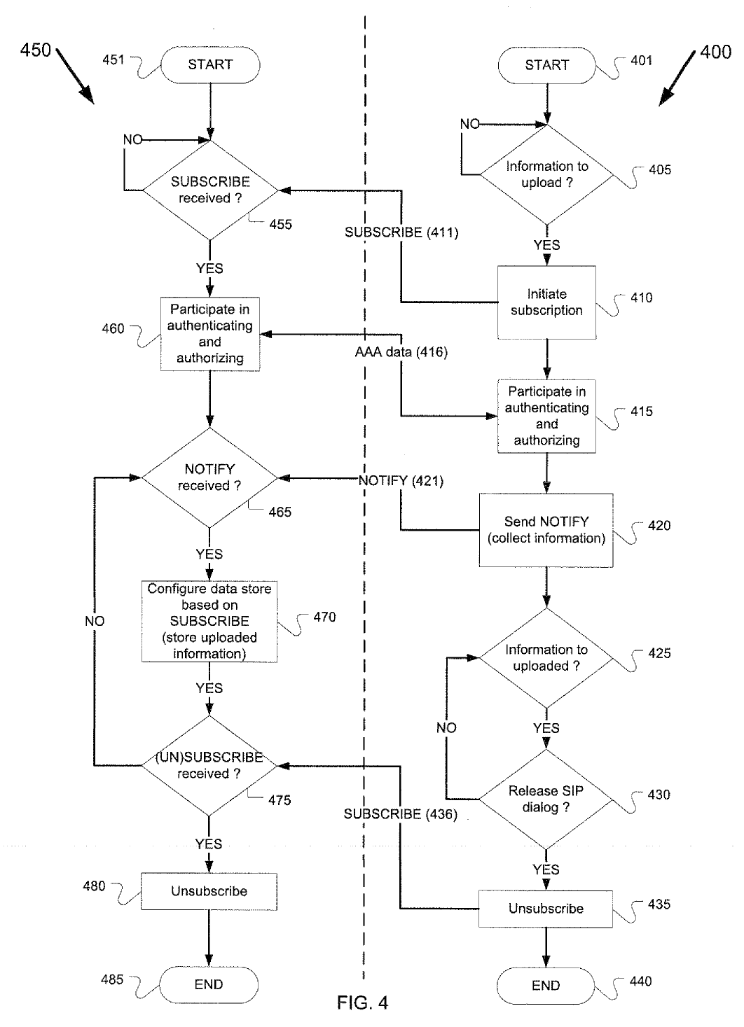

FIG. 4 is a flowchart of a SIP subscriber process 400 and a SIP server process 450 for communicating information in a SIP network.

The SIP subscriber process 400 and the SIP server process 450 start (401) and (451), respectively.

The SIP subscriber process 400 determines (405) whether to upload information. If the SIP subscriber process 400 determines (405) to upload information, the SIP subscriber process 400 initiates (410) a subscription with a SUBSCRIBE message 411 (described above); else the SIP subscriber process 400 continues to determine (405) whether to upload information.

The SIP server process 450 determines (455) whether the SUBSCRIBE message 411 is received. Upon determining (455) that the SUBSCRIBE message 411 is received, the SIP subscriber process 400 and the SIP server process 450 participate in authenticating and authorizing (415) and (460), respectively, with authentication and authorization data 416. The SIP subscriber process 400 and the SIP server process 450 may also participate in accounting.

The SIP subscriber process 400 uploads (420) information with a NOTIFY message 421 (described above). In uploading (420) the information, the SIP subscriber process 400 may collect or otherwise retrieve the information to be uploaded with the NOTIFY message 421.

The SIP server process 450 determines (465) whether the NOTIFY message 421 uploading information is received. If the SIP server process 450 determines (465) that the NOTIFY message 421 is received, the SIP server process 450 configures (470) a data store (or database) on the basis of the SUBSCRIBE message 411 and stores the information uploaded with the NOTIFY message 421.

Recall, a SUBSCRIBE message conveys or otherwise communicates from a SIP subscriber to a SIP server, an information package. The information package defines a set of information to be uploaded or otherwise reported from the SIP subscriber to the SIP server. As such, the SIP server process 450 configures (and stores) (470) per an information package.

The SIP subscriber process 400 determines (425) whether to upload information. The SIP subscriber process 400 may determine (425) to upload information on a timed or scheduled basis. Alternatively, the SIP subscriber process 400 may determine (425) to upload information on an event basis. In a convenient embodiment, when or a time the SIP subscriber process 400 uploads (420) information or otherwise determines (425) to upload information may be defined by an information package.

If the SIP subscriber process 400 determines (425) there is no information to upload, the SIP subscriber process 400 then determines (430) whether to release or otherwise end the SIP dialog. If the SIP subscriber process 400 determines (430) to release the SIP dialog, the SIP subscriber process 400 un-subscribes (435) with a SUBSCRIBE message 436 with the time to expire set to zero; else the SIP subscriber process 400 continues to determine (425) whether there is no information to upload.

The SIP server process 450 determines (475) whether the SUBSCRIBE message 436 with the time to expire set to zero is received. If the SIP server process 450 determines (475) that the SUBSCRIBE message 436 with the time to expire set to zero is received, the SIP server process 450 acknowledges that the SIP subscriber process 400 has no information to upload and un-subscribes (480) with a 200 OK message; else the SIP server process 450 continues to determine (465) whether the NOTIFY message 421 uploading information is received.

Alternatively, the SIP server process 450 releases (not shown) the SIP dialog and notifies (not shown) the SIP subscriber process 400 with a NOTIFY message that synchronizes the current state of the subscribed subscription.

The SIP subscriber process 400 and SIP server process 450 end (440) and (485), respectively, with information in the SIP network communicated.

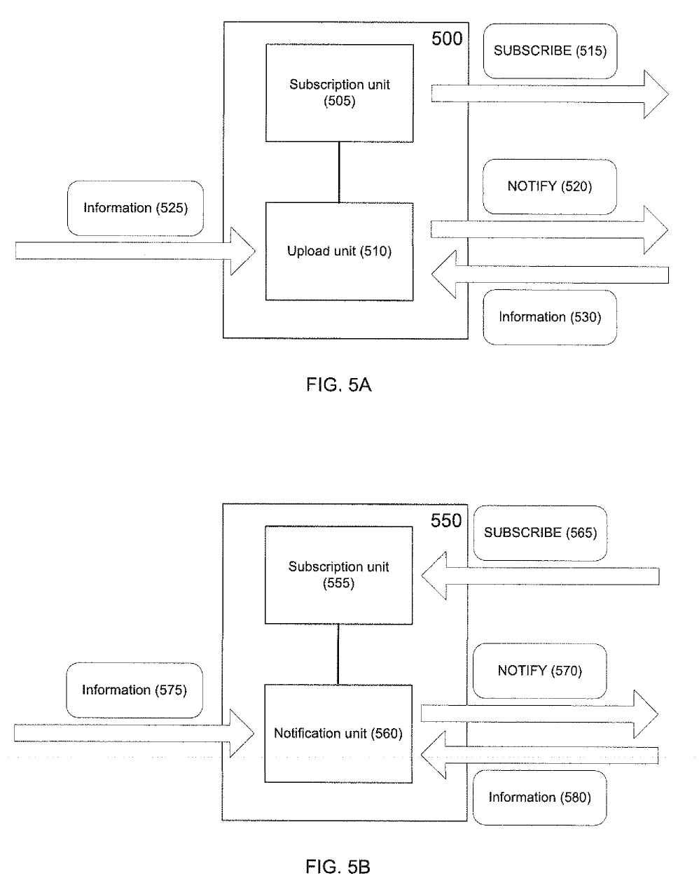

FIG. 5A is a block diagram of an example apparatus 500 to communicate information in a SIP network. The apparatus 500 has a subscription unit 505 and an upload unit 510 communicatively coupled to one another. The subscription unit 505, using a SUBSCRIBE message 515, creates a subscription by requesting to be notified by a SIP server with information of a state of a resource or of an event during a SIP dialog, and by informing the SIP server that the SIP server is to be uploaded with information other than a state of a resource or of an event during the SIP dialog.

The upload unit 510, using a NOTIFY message 520, during the SIP dialog, uploads the SIP server with information other than a state of a resource or of an event as informed 525, while being notified by the SIP server with information of a state of a resource or of an event as requested 530. Although, a NOTIFY message is normally used by a SIP server to notify a SIP subscriber during a SIP dialog with information of the state of the resource or of the event, in a convenient embodiment, the NOTIFY message 520 communicates or otherwise conveys both the information other than a state of a resource or of an event as informed 525 and the information of a state of a resource or of an event as requested 530.

The information as informed 525 includes, for example, information about a user, application or system. The apparatus 500 may collect the information as informed 525. Alternatively, the information as informed 525 may be given by, for example, a user, application or system using or otherwise associated with the apparatus 500.

FIG. 5B is a block diagram of an example apparatus 550 to communicate information in a SIP network. The apparatus 550 has a subscription unit 555 and a notification unit 560 communicatively coupled to one another. The subscription unit 555 creates a subscription responsive to a SIP subscriber (not shown) sending a SUBSCRIBE message 565 requesting to be notified with information of a state of a resource or of an event during a SIP dialog, and informing that the SIP subscriber uploads information other than a state of a resource or of an event during the SIP dialog.

The notification unit, using a NOTIFY message 570, during the SIP dialog, notifies the SIP subscriber with information of a state of a resource or of an event as requested 575, while being uploaded by the SIP subscriber with information other than a state of a resource or of an event as informed 580. Although, a NOTIFY message is normally used by a SIP server to notify a SIP subscriber during a SIP dialog with information of the state of the resource or of the event, in a convenient embodiment, the NOTIFY message 570 communicates or otherwise conveys both the information of a state of a resource or of an event as requested 575 and the information other than a state of a resource or of an event as informed 580.

The information as requested 575 includes information required for services, such as automatic callback services (based on terminal state events), buddy lists (based on user presence events), message waiting indications (based on mailbox state change events), and PSTN, and Internet Internetworking (PINT) status (based on call state events).

While this invention has been particularly shown and described with references to example embodiments thereof, it will be understood by those skilled in the art that various changes in form and details may be made therein without departing from the scope of the invention encompassed by the appended claims.

It should be understood that the network, flow, and block diagrams may include more or fewer elements, be arranged differently, or be represented differently. It should be understood that implementation may dictate the network, flow, and block diagrams and the number of network, flow, and block diagrams illustrating the execution of embodiments of the invention.

It should be understood that elements of the network, flow, and block diagrams described above may be implemented in software, hardware, or firmware. In addition, the elements of the network, flow, and block diagrams described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

What is claimed is:

1. A method for communicating information in a session initiated protocol (SIP) network, the method comprising:
while requesting a SIP server notify a SIP subscriber during a SIP dialog with information of a state of a resource or of an event, informing the SIP server that the SIP subscriber uploads information other than a state of a resource or of an event; and
uploading the information as informed to the SIP server during the SIP dialog.

2. The method of claim 1 wherein informing the SIP server includes informing the SIP server with a SUBSCRIBE message normally used by the SIP subscriber to request the SIP server notify the SIP subscriber during the SIP dialog of the information of the state of the resource or of the event.

3. The method of claim 1 wherein uploading the information includes uploading the information with a NOTIFY message normally used by the SIP server to notify the SIP subscriber during the SIP dialog of the information of the state of the resource or of the event as requested.

4. The method of claim 1 wherein uploading the information depends on an information package definition.

5. The method of claim 1 wherein uploading the information includes uploading information about a user, application, system or combination thereof.

6. The method of claim 1 further comprising the SIP server authenticating and authorizing the SIP subscriber to upload during the SIP dialog the information as informed to the SIP server.

7. A system to communicate information in a session initiated protocol (SIP) network, the system comprising:
a SIP server; and
a SIP subscriber networked to the SIP server, the SIP subscriber, while requesting the SIP server notify the SIP subscriber during a SIP dialog with information of a state of a resource or of an event, the SIP subscriber informing the SIP server that the SIP subscriber uploads information other than a state of a resource or of an event; and the SIP subscriber uploading the information as informed to the SIP server during the SIP dialog.

8. The system of claim 7 wherein the SIP subscriber informing includes the SIP subscriber informing the SIP server with a SUBSCRIBE message normally used by the SIP subscriber to request the SIP server notify the SIP subscriber during the SIP dialog of the information of the state of the resource or of the event.

9. The system of claim 7 wherein the SIP subscriber uploading the information includes the SIP subscriber uploading the information with a NOTIFY message normally used by the SIP server to notify the SIP subscriber during the SIP dialog of the information of the state of the resource or of the event as requested.

10. The system of claim 7 wherein the SIP subscriber uploading the information depends on an information package definition.

11. The system of claim 7 wherein the SIP subscriber uploading the information includes uploading information about a user, application, system or combination thereof.

12. A computer program product including a computer readable medium having a computer readable program, the computer readable program, when executed by a computer causes the computer to:
while requesting a SIP server notify a SIP subscriber during a SIP dialog with information of a state of a resource or of an event, inform the SIP server that the SIP subscriber uploads information other than a state of a resource or of an event; and
upload the information as informed to the SIP server during the SIP dialog.

13. A method for communicating information in a session initiated protocol (SIP) network, the method comprising:
creating a subscription responsive to a SIP subscriber requesting to be notified with information of a state of a resource or of an event during a SIP dialog, and responsive to the SIP subscriber informing that the SIP subscriber uploads information other than a state of a resource or of an event during the SIP dialog; and
during the SIP dialog, notifying the SIP subscriber with information of a state of a resource or of an event as requested, while being uploaded by the SIP subscriber with information other than a state of a resource or of an event as informed.

14. The method of claim 13 wherein creating the subscription includes creating the subscription responsive to the SIP subscriber informing that the SIP subscriber uploads information about a user, application, system or combination thereof during the SIP dialog.

15. The method of claim 13 further comprising authenticating and authorizing the SIP subscriber to upload information other than a state of a resource or of an event as informed during the SIP dialog.

16. An apparatus to communicate information in a session initiated protocol (SIP) network, the apparatus comprising:
a subscription unit to create a subscription responsive to a SIP subscriber requesting to be notified with information of a state of a resource or of an event during a SIP dialog, and responsive to the SIP subscriber informing that the SIP subscriber uploads information other than a state of a resource or of an event during the SIP dialog; and
a notification unit communicatively coupled to the subscription unit to, during the SIP dialog, notify the SIP subscriber with information of a state of a resource or of an event as requested, while being uploaded by the SIP subscriber with information other than a state of a resource or of an event as informed.

17. The apparatus of claim 16 further comprising an authenticating and authorizing unit communicatively coupled to the subscription unit to authenticate and authorize the SIP subscriber to upload information other than a state of a resource or of an event as informed during the SIP dialog.

18. A computer program product including a computer readable medium having a computer readable program, the computer readable program, when executed by a computer causes the computer to:
create a subscription responsive to a SIP subscriber requesting to be notified with information of a state of a resource or of an event during a SIP dialog, and responsive to the SIP subscriber informing that the SIP subscriber uploads information other than a state of a resource or of an event during the SIP dialog; and during the SIP dialog, notify the SIP subscriber with information of a state of a resource or of an event as requested, while being uploaded by the SIP subscriber with information other than a state of a resource or of an event as informed.

19. A method for communicating information in a session initiated protocol (SIP) network, the method comprising:
creating a subscription by requesting to be notified by a SIP server with information of a state of a resource or of an event during a SIP dialog, and informing the SIP server that the SIP server is to be uploaded with information other than a state of a resource or of an event during the SIP dialog; and
during the SIP dialog, uploading the SIP server with information other than a state of a resource or of an event as informed, while being notified by the SIP server with information of a state of a resource or of an event as requested.

20. The method of claim 19 wherein creating the subscription includes creating the subscription by informing the SIP server that the SIP server is to be uploaded with information about a user, application, system or combination thereof during the SIP dialog.

21. The method of claim 19 further comprising authenticating and authorizing to upload the SIP server with information other than a state of a resource or of an event as informed during the SIP dialog.

22. An apparatus to communicate information in a session initiated protocol (SIP) network, the apparatus comprising:
a subscription unit to create a subscription by requesting to be notified by a SIP server with information of a state of a resource or of an event during a SIP dialog, and informing the SIP server that the SIP server is to be uploaded with information other than a state of a resource or of an event during the SIP dialog; and
a upload unit communicatively coupled to the subscription to, during the SIP dialog, upload the SIP server with information other than a state of a resource or of an event as informed, while being notified by the SIP server with information of a state of a resource or of an event as requested

23. The apparatus of claim 22 further comprising an authenticating and authorizing unit communicatively coupled to the subscription unit to authenticate and authorize to upload the SIP server with information other than a state of a resource or of an event as informed during the SIP dialog.

24. A computer program product including a computer readable medium having a computer readable program, the computer readable program, when executed by a computer causes the computer to:
create a subscription by requesting to be notified by a SIP server with information of a state of a resource or of an event during a SIP dialog, and informing the SIP server that the SIP server is to be uploaded with information other than a state of a resource or of an event during the SIP dialog; and
during the SIP dialog, upload the SIP server with information other than a state of a resource or of an event as informed, while being notified by the SIP server with information of a state of a resource or of an event as requested.
